(19) United States
(12) Patent Application Publication
(10) Pub. No.: US 2025/0254598 A1
(43) Pub. Date: Aug. 7, 2025

(54) METHODS, DEVICES, AND COMPUTER READABLE MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/855,096

(22) PCT Filed: Apr. 15, 2022
(86) PCT No.: PCT/CN2022/087198

§ 371 Date: Oct. 8, 2024

(51) Int. Cl. H04W 40/12; H04W 24/10; H04W 40/20; H04W 40/22

(52) U.S. Cl. CPC H04W 40/12; H04W 24/10; H04W 40/205; H04W 40/22

(57) ABSTRACT

Embodiments of the present disclosure relate to methods, devices, and computer readable medium for communication. According to embodiments of the present disclosure, a network device or a repeater determines whether applying the repeater for building a communication between the network device and a terminal device based on measured information of the repeater. The measured information comprises one or more of: position information of the repeater, angle information of the repeater and self-interference information of the repeater. In this way, it avoids low efficiency scheduling of repeater.

### TECHNICAL FIELD

Embodiments of the present disclosure generally relate to the field of telecommunication, and in particular, to methods, devices, and computer readable medium for communication.

### BACKGROUND

Coverage is a fundamental aspect of cellular network deployments. Mobile operators rely on different types of network nodes to offer blanket coverage in their deployments. Deployment of regular full-stack cells is one option but it may not be always possible (e.g., no availability of backhaul) or economically viable. As a result, new types of network nodes have been considered to increase mobile operators' flexibility for their network deployments. For example, Integrated Access and Backhaul (IAB) was introduced as a new type of network node not requiring a wired backhaul. Another type of network node is the radio frequency (RF) repeater which simply amplify-and-forward any signal that they receive. RF repeaters have seen a wide range of deployments in 2G, 3G and 4G to supplement the coverage provided by regular full-stack cells. While an RF repeater presents a cost effective means of extending network coverage, it has its limitations. An RF repeater simply does an amplify-and-forward operation without being able to take into account various factors that could improve performance. Such factors may include information on semi-static and/or dynamic downlink/uplink configuration, adaptive transmitter/receiver spatial beamforming, ON-OFF status, etc. Therefore, enhancements on repeaters are needed.

### SUMMARY

In general, example embodiments of the present disclosure provide a solution for communication.

In a first aspect, there is provided a method for communication. The method comprises receiving, at a network device, measured information from a repeater, wherein the measured information comprises at least one of: position information of the repeater, angle information of the repeater, or self-interference information of the repeater; and transmitting an indication of the repeater to the repeater, the indication being used for indicating whether applying the repeater for building a communication between the network device and the terminal device based at least on the measured information.

In a second aspect, there is provided a method for communication. The method comprises transmitting, at a repeater, measured information to the network device, wherein the measured information comprises at least one of: position information of the repeater, angle information of the repeater, or self-interference information of the repeater; and receiving an indication from the network device, the indication being used for indicating whether applying the repeater for building a communication between the network device and a terminal device.

In a third aspect, there is provided a method for communication. The method comprises: determining, at a repeater, measured information, wherein the measured information comprises at least one of: position information of the repeater, angle information of the repeater, or self-interference information of the repeater; transmitting, to the network device, a feedback information to report whether applying the repeater for building a communication between the network device and the terminal device based at least on the measured information.

In a fourth aspect, there is provided a network device. The network device comprises a processing unit; and a memory coupled to the processing unit and storing instructions thereon, the instructions, when executed by the processing unit, causing the network device to carry out the method according to the first aspect.

In a fifth aspect, there is provided a repeater. The repeater comprises a processing unit; and a memory coupled to the processing unit and storing instructions thereon, the instructions, when executed by the processing unit, causing the repeater to carry out the method according to the second or third aspect.

In a sixth aspect, there is provided a computer readable medium having instructions stored thereon, the instructions, when executed on at least one processor, causing the at least one processor to carry out the method according to the first or second or third aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is schematic diagrams of a communication environment in which embodiments of the present disclosure can be implemented;

FIG. 2 illustrates a signaling flow for communications according to some embodiments of the present disclosure;

FIGS. 3A and 3B illustrate signaling flows for communications according to some embodiments of the present disclosure, respectively;

FIG. 4 is a schematic diagram of a communication environment comprising a network device, a terminal device and a repeater according to some embodiments of the present disclosure;

FIG. 5 is a schematic diagram of a communication environment comprising a network device, a terminal device and a repeater according to some embodiments of the present disclosure;

FIG. 6 is a schematic diagram of receiving and transmitting beams according to some embodiments of the present disclosure;

FIG. 7 is a flowchart of an example method in accordance with an embodiment of the present disclosure;

FIG. 8 is a flowchart of an example method in accordance with an embodiment of the present disclosure;

FIGS. 9A and 9B are schematic diagrams of measuring signal strength of self-interference according to some embodiments of the present disclosure, respectively;

FIG. 10 is a flowchart of an example method in accordance with an embodiment of the present disclosure;

FIG. 11 is a flowchart of an example method in accordance with an embodiment of the present disclosure;

FIG. 12 is a flowchart of an example method in accordance with an embodiment of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space bome vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial Intelligence (AI) or Machine Learning (ML) capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, enhancements on repeaters are needed. A network-controlled repeater is an enhancement over conventional RF repeaters with the capability to receive and process side control information from the network. Side control information could allow a network-controlled repeater to perform its amplify-and-forward operation in a more efficient manner. However, if the angle between the receiving direction and transmitting direction is too small, the repeater cannot operate well.

In order to solve at least part of the above problems or other potential problems, solutions on determining a proper repeater are proposed. According to embodiments of the present disclosure, a network device or a repeater determines whether applying the repeater for building a communication between the network device and a terminal device based on measured information of the repeater. The measured information comprises one or more of: position information of the repeater, angle information of the repeater and self-interference information of the repeater. In this way, it avoids low efficiency scheduling of repeater.

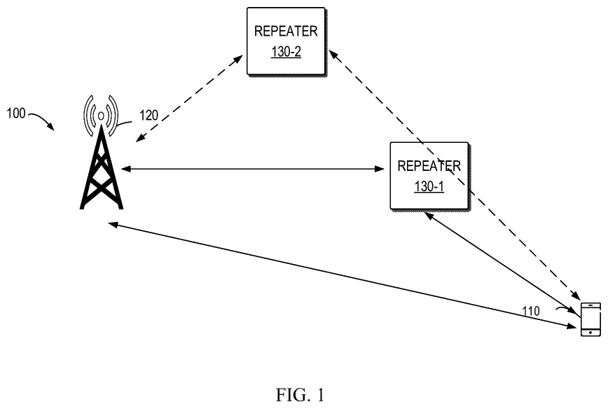

FIG. 1 illustrates a schematic diagram of a communication system in which embodiments of the present disclosure can be implemented. The communication system 100, which is a part of a communication network, comprises a terminal device 110.

The communication system 100 further comprises a network device 120. In the communication system 100, the network device 120 and the terminal devices 110 can communicate data and control information to each other. The terminal devices 110 can also communicate with each other. The numbers of terminal devices shown in FIG. 1 are given for the purpose of illustration without suggesting any limitations. The interface between the terminal device 110 and the network device 120 may be called Uu interface. The communication system 100 also comprises one or more repeaters (for example, the repeaters 130-1 and 130-2). The repeater can be any suitable devices which are capable of communications.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

The terms “beam” and “spatial domain filter” used herein can be interchangeable. The terms “receiving beam” and “spatial domain receiving filter” used herein can be interchangeable. The terms “transmitting beam” and “spatial domain transmission filter” used herein can be interchangeable.

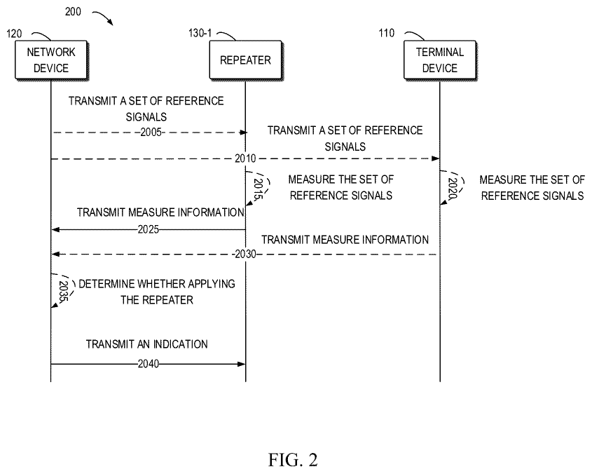

Embodiments of the present disclosure will be described in detail below. Reference is first made to FIG. 2, which shows a signaling chart illustrating process 200 among the terminal device and the network device according to some example embodiments of the present disclosure. Only for the purpose of discussion, the process 200 will be described with reference to FIG. 1. The process 200 may be applied to a scenario where the network device determines whether applying the repeater for building the communication between the network device and the terminal device. Building the communication between the network device and the terminal device means that maintaining the network device-repeater link and the repeater-terminal device link simultaneously.

The network device 120 may configure a set of reference signals for the terminal device 110 and the repeater 130-1. In some embodiments, the set of reference signals may be configured for measuring self-interference.

For example, the network device 120 may transmit 2010 the set of reference signals to the terminal device 110. The network device 120 may also transmit 2005 the set of reference signals to the repeater 130-1. In some embodiments, the set of reference signals may be a set of positioning reference signals. Alternatively, the set of reference signals may be a set of channel state information reference signals. It should be noted that the set of reference signals may be any proper signals. It should be noted that the order the transmission 2005 and the transmission 2010 shown in FIG. 2 is only an example. The transmission 2005 and the transmission 2010 may be performed simultaneously or in any proper order.

In some embodiments, the repeater 130-1 may measure 2015 the set of reference signals. For example, the repeater 130-1 may measure reference signal received power (RSRP) based on the set of reference signals. Alternately, the repeater 130-1 may measure signal to noise ratio (SNR) based on the set of reference signals. In some other embodiments, the repeater 130 may measure signal to interference and noise ratio (SINR) based on the set of reference signals.

In some embodiments, the terminal device 110 may measure 2020 the set of reference signals. For example, the terminal device 110 may measure RSRP based on the set of reference signals. Alternately, the terminal device 110 may measure SNR based on the set of reference signals. In some other embodiments, the terminal device 110 may measure SINR based on the set of reference signals. It should be noted that the order the measurement 2015 and the measurement 2020 shown in FIG. 2 is only an example. The measurement 2015 and the measurement 2020 may be performed simultaneously or in any proper order.

The repeater 130-1 transmits 2025 measured information of the repeater 130-1 to the network device. In some embodiments, the measured information may comprise position information of the repeater 130-1. Alternatively or in addition, the measured information may comprise angle information of the repeater 130-1. For example, the angle information may comprise angle difference information. In some other embodiments, the measured information may comprise self-interference information of the repeater 130-1. In some embodiments, the terminal device 110 may transmit 2030 position information to the network device 120.

The network device 120 may determine 2035 whether applying the repeater 130-1 for building the communication between the network device 120 and the terminal device 110. In some embodiments, the network device 120 may determine whether one or more conditions associated with the repeater 130-1 are fulfilled based on the position information of the repeater 130-1 and the position information of the terminal device 120.

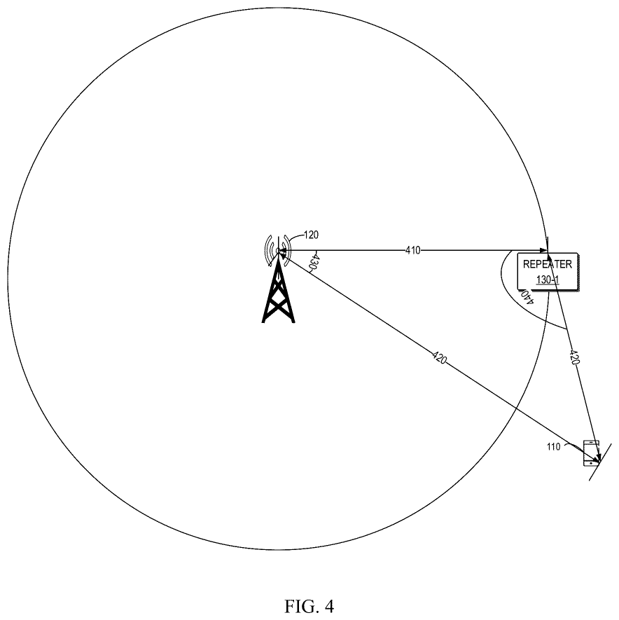

In some embodiment, the conditions may comprise a first condition where a first range between the network device 120 and the repeater 130-1 is smaller than a second range between the network device 120 and the terminal device 110. For example, as shown in FIG. 4, if the first range 410 is smaller than the second range 420, the network device 120 may determine that the first condition is fulfilled.

Alternatively or in addition, the conditions may comprise a second condition where a first absolute value of a first angle between a first line and a second line is smaller than a first threshold value. The first line may be between the network device 120 and the terminal device 110 and the second line may be between the network device 120 and the repeater 130-1. In some embodiments, the first angle may be a vertical angle. Alternatively or in addition, the first angle may be an azimuth angle. If the first angle comprises the vertical angle and the azimuth angle, the first threshold value may also comprise a vertical threshold value and an azimuth angle threshold value. The angle can be measured based on global coordinate system (GCS), or local coordinate system (LCS). In the global coordinate system (GCS), estimated azimuth angle is measured relative to geographical North and is positive in a counter-clockwise direction and estimated vertical angle is measured relative to zenith and positive to horizontal direction. In the local coordinate system (LCS), estimated azimuth angle is measured relative to x-axis of LCS and positive in a counter-clockwise direction and estimated vertical angle is measured relative to z-axis of LCS and positive to x-y plane direction.

For example, as shown in FIG. 4, the first angle 430 can be represented as<LUgR where U represents the terminal device 110, g represents the network device 120 and R represents the repeater 130-1. In other words, the first angle 430 can be the angle at the network device 120 with respect to the terminal device 110 and the repeater 130-1. In some embodiments, if the first absolute value of the first angle 430 is smaller than the first threshold value (for example, 90 degrees), the network device 120 may determine that the second condition is fulfilled.

In some embodiments, the conditions may comprise a third condition where a second absolute value of a second angle between a third line and a fourth line is larger than a second threshold value. The third line may be between the repeater 130-1 and the network device 120. In other words, the third line and the second line can be the same. The fourth line may be between the repeater 130-1 and the terminal device 110. In some embodiments, the second angle may be a vertical angle. Alternatively or in addition, the second angle may be an azimuth angle. If the second angle comprises the vertical angle and the azimuth angle, the second threshold value may also comprise a vertical threshold value and an azimuth angle threshold value. The angle can be measured based on the GCS, or the LCS. In the GCS, estimated azimuth angle is measured relative to geographical North and is positive in a counter-clockwise direction and estimated vertical angle is measured relative to zenith and positive to horizontal direction. In the LCS, estimated azimuth angle is measured relative to x-axis of LCS and positive in a counter-clockwise direction and estimated vertical angle is measured relative to z-axis of LCS and positive to x-y plane direction.

For example, as shown in FIG. 4, the second angle 440 can be represented as<gRU, where U represents the terminal device 110, g represents the network device 120 and R represents the repeater 130-1. In other words, the second angle 440 can be the angle at the repeater 130-1 with respect to the network device 120 and the terminal device 110. In some embodiments, if the second absolute value of the second angle 440 is smaller than the second threshold value (for example, 45 degrees), the network device 120 may determine that the third condition is fulfilled.

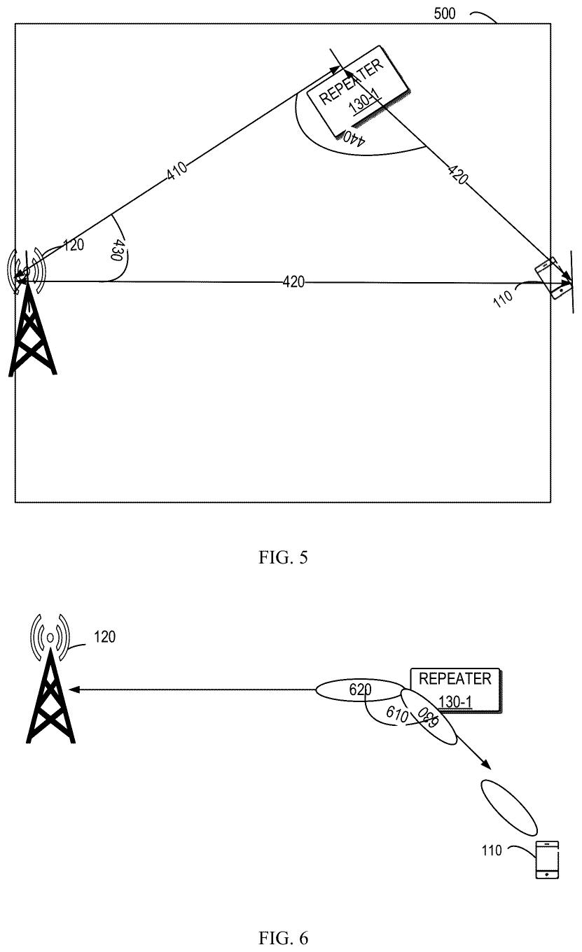

In some embodiments, if the first condition and the second condition are fulfilled, the network device 120 may determine applying the repeater 130-1 for building the communication between the network device 120 and the terminal device 110-1. Alternatively or in addition, if the third condition and the second condition are fulfilled, the network device 120 may determine applying the repeater 130-1 for building the communication between the network device 120 and the terminal device 110-1. Alternatively or in addition, if the third condition is fulfilled, the network device 120 may determine applying the repeater 130-1 for building the communication between the network device 120 and the terminal device 110-1. In some embodiments, for example, as shown in FIG. 5, if the repeater 130-1 is within the area 500, the network device 120 may determine applying the repeater 130-1 for building the communication between the network device 120 and the terminal device 110-1.

In some embodiments, the position information of the repeater 130-1 may indicate the first range between the network device 120 and the repeater 130-1. For example, as shown in FIG. 4, the position information of the repeater 130-1 may directly indicate the first range 410.

Alternatively or in addition, the position information of the repeater 130-1 may indicate a third angle between a fifth line and a first reference line with a first direction. The fifth line may between the network device 120 and the repeater 130-1. In other words, the third line, the second line and the fifth line can be the same. The first reference line with the first direction may be configured by the network device 120. In some other embodiments, the position information of the terminal device 110 may indicate a fourth angle between a sixth line and a second reference line with a second direction. The sixth line may be between the terminal device 110 and the network device 120. The second reference line with the second direction may be configured by the network device 120. In some embodiments, the first reference line and the second reference line may be same. In this case, the network device 120 may determine the first angle based on the third angle and the fourth angle.

In some embodiments, the network device 120 may determine the first range based on the position information of the repeater 130-1. For example, the network device 120 may determine the first range 410 based on the position of the network device 120 and the position of the repeater 130-1. In this case, the position information of the repeater 130-1 may comprise coordinate values of the repeater 130-1 in a coordinate system. The network device 120 may determine its coordinate values in the coordinate system. In this case, the first range may be determined based on the coordinate values.

In some embodiments, the network device 120 may determine the second range based on the position information of the terminal device 110. For example, the network device 120 may determine the second range 420 based on the position of the network device 120 and the position of the terminal device 110. In this case, the position information of the terminal device 110 may comprise coordinate values of the terminal device 110 in a coordinate system. The network device 120 may determine its coordinate values in the coordinate system. In this case, the second range may be determined based on the coordinate values.

In some other embodiments, the network device 120 may determine the first angle based on the position information of the repeater 130-1 and the position information of the terminal device 110. The network device 120 may determine the second angle based on the position information of the repeater 130-1 and the position information of the terminal device 110. For example, the position information of the terminal device 110 may comprise coordinate values of the terminal device 110 in a coordinate system and the position information of the repeater 130-1 may comprise coordinate values of the repeater 130-1 in the coordinate system. The network device 120 may determine its coordinate values in the coordinate system. In this case, the first angel and/or the second angle may be determined based on the coordinate values.

In some embodiments, the position information of the repeater 130-1 may be determined and stored by the network device 120 at the time of network planning. In some embodiments, the location of the repeater 130-1 may be fixed. In this case, the position information of the repeater 130-1 may be transmitted to the network device 120.

In some embodiments, the network device 120 may determine whether an angle difference between a receiving beam and a transmitting beam of the repeater 130-1 exceeds a first threshold angle based on the angle information of the repeater 130-1. If the angle difference exceeds the first threshold angle, the network device 120 may determine applying the repeater 130-1 for building the communication between the network device 120 and the terminal device 110. In other words, the indication may be used to indicate that applying the repeater 130-1 for building the communication between the network device 120 and the terminal device 110. For example, as shown in FIG. 6, if the angle difference 610 between the receiving beam 620 and the transmitting beam 630 exceeds the first threshold angle, the repeater 130-1 may be applied for building the communication between the network device 120 and the terminal device 110.

In some embodiments, the angle information may be per beam pair. A beam pair may comprise a receiving beam and a transmitting beam. For example, if the repeater 130-1 has 4 receiving beams and 4 transmitting beams, there may be 16 beam pairs. In this case, the angle information may comprise angle information of the 16 beam pairs. The angle information may comprise one or more of: a first angle difference in azimuth direction, a second angle difference in vertical direction, whether the receiving beam and the transmitting beam are in same or difference polarization direction. In some embodiments, the first angle difference may be based on a local coordinate system of the repeater 130-1 or a GCS. Alternatively or in addition, the second angle difference may be based on the local coordinate system of the repeater 130-1 or a GCS.

The first angle difference and/or the second angle difference may be indicated in quantized values in a range from a first angle to a second angle. For example, the reported value may be one of a quantized value from angle α₀ to angle α_{N}. In this case, α₀ is smaller than α_{N} and 2\hat{ }b values may be quantized. In some embodiments, if the angle difference is larger than a first predetermined value (α_{N}), this quantized value may not be reported. Alternatively, if the angle difference is smaller than a second predetermined value (α₀), an invalid value may be used by taking place of quantized value for reporting this case. In some embodiments, an reporting condition can be defined, for example, repeater reports the angle difference only when the angle difference is smaller than α_{N}, thereby decreasing complexity and payload of repeater to report the angle difference information. Alternatively, the angle difference smaller than α₀ is quantized as α₀. Alternatively, the angle difference is an absolute value.

In some embodiments, the angle information may be per beam. For example, if the repeater 130-1 has 4 receiving beams and 4 transmitting beams, the angle information may comprise angle information of the 8 beams. The angle information may indicate: a direction of the beam, a polarization of the beam. The beam may be a receiving beam (for example, the beam 620) or a transmission beam (for example, the beam 630). In some embodiments, the direction of the beam may comprise azimuth direction and/or vertical direction. In some embodiments, both directions may be angle information based on a coordinate system of each antenna panel at the repeater 130-1. Alternatively, both directions may be angle information based on a GCS.

In some embodiments, the first threshold angle may be a fixed value. For example, the first threshold αₜₕ may be fixed and not smaller than 90 degree. Alternatively, the first threshold angle may be determined based on a SINR or SNR reported by the repeater 130-1. In some embodiments, different angle differences may lead to different signal strength of self-interference for a same beam pair. Table 1 below shows an example relation between angle difference and self-interference where S₀>S₁>S₂, and α₀<α₁<α₂. It should be noted that Table 1 is only an example not limitation. Therefore, associating the angle threshold with SINR or SNR, maximizes the application of repeater when making sure the self-interference is negligible by comparing with noise power. For example, high SINR may correspond to high threshold angle (αₜₕ=α₂) and low SINR may correspond to low threshold angle (αₜₕ=α₀), as shown in Table 1, where SNR₀<SNR₁<SNR₂.

TABLE 1

| Angle difference | Self-interference | SINR or SNR |
|---|---|---|
| \|α\| ≤ α₀ | S₀ | SNR₀ |
| α₀ < \|α\| ≤ α₁ | S₁ | SNR₁ |
| α₁ < \|α\| ≤ α₂ | S₂ | SNR₂ |

In some embodiments, the first threshold angle may be determined based on a SINR or SNR reported by the terminal device 110. The SINR reported by the terminal device 110 may correspond to whole link. Alternatively, the predefined or preconfigured threshold may be determined based on the second SINR or SNR report by the repeater 130-1 and the terminal device 110.

Alternatively, the first threshold angle may be determined based on a transmission power of the repeater 130-1. For example, different transmitted powers may lead to different signal strength of self-interferences. For example, higher power may lead to larger signal strength of self-interference and lower power may lead to lower signal strength of self-interference. In this case, higher power may correspond to higher threshold angle and lower power may correspond to lower threshold angle.

In some embodiments, the first threshold angle may be determined based on a beam width of a beam of the repeater 130-1. The beam width may comprise the beam width of the receiving beam and/or the beam width of the transmitting beam. For example, different beam widths may lead to different self-interference under a same angle difference. The wider beam lead to larger angle range to introduce self-interference signal. In this case, wider beam may correspond to larger threshold angel, thereby avoiding self-interference.

In some other embodiments, the first threshold angle may be determined based on the number of beams at the repeater 130-1. For example, different number of beams may lead to different self-interference under a same angle difference. The number of beams may be associated with beam width. For example, more beams may lead to narrower beam and less beams may lead to wider beam. In this case, more beams or narrower beams may correspond to smaller threshold angel, thereby maximum the application area of repeater when avoiding self-interference or making sure the self-interference is negligible.

Alternatively, the first threshold angle may be determined based on the number of antennas at the repeater. For example, different antenna number may lead to different self-interference under a same angle difference. The number of antenna may be associated with beam width. For example, more antennas may lead to narrower beam and less antennas may lead to wider beam. In this case, more antennas may correspond to smaller threshold angle to maximum the application area of repeater when avoiding self-interference or making sure the self-interference is negligible.

Table 2 below shows an example relation among beam width, the number of beams, the number of antennas, and angle threshold, where αₜₕ_{₂}>aₜₕ_{₁}>aₜₕ_{₀}, θ₂>θ₁>θ₀, N₀>N₁>N₂, M₀>M₁>M₂. It should be noted that Table 2 is only an example not limitation.

TABLE 2

| | | | Threshold |
|---|---|---|---|
| Beam width | Number of beams | Number of antennas | Angle |
| θ_{3 dB} ≤ θ₀ | N₀ ≤ N_{beam} | M₀ ≤ Mₐₙₜ | αₜₕ_{₀} |
| θ₀ < θ_{3 dB} ≤ θ₁ | N₁ ≤ N_{beam} < N₀ | M₁ ≤ Mₐₙₜ < M₀ | αₜₕ_{₁} |
| θ₁ < θ_{3 dB} ≤ θ₂ | N₂ ≤ N_{beam} < N₁ | M₂ ≤ Mₐₙₜ < M₁ | αₜₕ_{₂} |

In some embodiments, the first threshold angle may be determined based on a polarization direction of a receiving beam and a polarization direction of a transmitting beam. For example, if the receiving beam and the transmitting beam have a same polarization direction, the first threshold may be represented as αₜₕ_{₁}. If the receiving beam and the transmitting beam have different polarization directions, the first threshold may be represented as αₜₕ₂. In this case, the αₜₕ₁ may be larger than αₜₕ₂. Table 3 below shows an example relation among beam width, polarization direction, and threshold angle, where αₜₕ_{₅}>αₜₕ_{₄}>aₜₕ_{₃}>αₜₕ_{₂}>αₜₕ_{₁}>αₜₕ_{₀}, θ₂>θ₁>θ₀, N₀>N₁>N₂, M₀>M₁>M₂. It should be noted that Table 3 is only an example not limitation.

TABLE 3

| Polarization direction | Beam width | Threshold Angle |
|---|---|---|
| different | θ_{3 dB} ≤ θ₀ | αₜₕ_{₀} |
| | θ₀ < θ_{3 dB} ≤ θ₁ | αₜₕ_{₁} |
| | θ₁ < θ_{3 dB} ≤ θ₂ | αₜₕ_{₂} |
| same | θ_{3 dB} ≤ θ₀ | αₜₕ_{₃} |
| | θ₀ < θ_{3 dB} ≤ θ₁ | αₜₕ_{₄} |
| | θ₁ < θ_{3 dB} ≤ θ₂ | αₜₕ_{₅} |

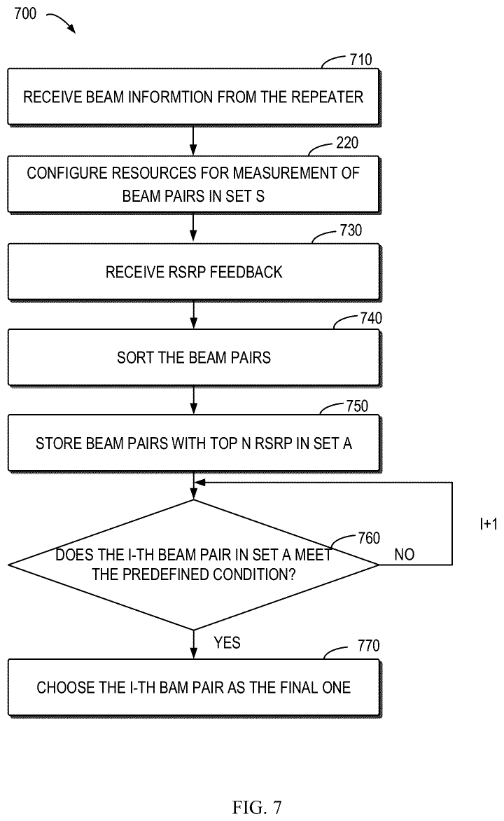

In some embodiments, the repeater 130-1 may transmit beam information of beam pairs and/or beam to the network device 120. The network device 120 may also receive RSRP information of the beam pairs. The network device 120 may determine a beam pair based on at least one of beam information, the conditions or RSRP. For example, the network device 120 may determine whether a candidate beam pair meets an angle difference condition based on the beam information. The network device 120 may also determine whether the candidate beam pair meets a RSRP condition based on the RSRP information. In this case, if the candidate beam pair meets the angle difference condition and the RSRP condition, the network device 120 may select the candidate beam pair as a target beam for building the communication. In some embodiments, if there are multiple beam pairs meet the two conditions, then a candidate beam pair with highest RSRP may be chosen as the target beam. In some embodiments, if there are multiple beam pairs meet the two conditions, then a candidate beam pair with largest angle difference may be chosen as the target beam. FIGS. 7 and 8 show flowcharts of example method 700 and 800 for determining the target beam pair in accordance with an embodiment of the present disclosure.

Referring to FIG. 7, at block 710, the network device 120 receives beam information of beams from the repeater 130-1. Beams can comprise receiving beam and/or transmission beam. For example, the beam information may indicate the number of beams. The beam information may also indicate directions of beams. Alternatively, the beam information may indicate polarization of beams.

At block 720, the network device 120 configures resources for measurement of beam pairs in set S. The set S can be the whole set including all beam pairs.

At block 730, the network device 120 receives RSRP feedback. In some embodiments, the network device 120 may receive RSRP feedback from the repeater 130-1. Alternatively, the network device 120 may receive RSRP feedback from the terminal device 110.

At block 740, the network device 120 sorts the beam pairs according to the RSRP feedback. At block 750, the network device 120 stores the beam pairs with top N RSRPs in set A in descending order. In some embodiments, the network device 120 may store the beam pairs with RPRP larger than a RSRP threshold in set A in descending order. The set A can be a subset of the set S.

At block 760, the network device 120 determines whether the i-th beam pair in set A meets the predefined condition. The value of i may be started from 1. The predefined condition may comprise one or more aforementioned conditions, for example, the first condition, the second condition, the third condition, or angle difference condition. If the i-th beam pair does not meet the predefined condition(s), the network device 120 may determine whether (i+1)-th beam pair in set A meets the predefined condition. If the i-th beam pair meets the predefined condition, at block 770, the network device 120 chooses the i-th beam pair in set A as the final one or the target one.

Referring to FIG. 8, at block 810, the network device 120 receives beam information of beams from the repeater 130-1. Beams can comprise receiving beam and/or transmission beam. For example, the beam information may indicate the number of beams. The beam information may also indicate directions of beams. Alternatively, the beam information may indicate polarization of beams.

At block 820, the network device 120 determines those beam pairs which meets the predefined condition from set S. The predefined condition may comprise one or more aforementioned conditions, for example, the first condition, the second condition, the third condition, or angle difference condition. The set S can be the whole set including all beam pairs.

At block 830, the network device 120 stores those beam pairs which meet the predefined condition in set B. The set B can be a subset of the set S. At block 840, the network device 120 transmits the beam pair information in set B to the repeater 130-1.

At block 850, the network device 120 configures resources for measurement of beam pairs in set B.

At block 860, the network device 120 receives RSRP feedback. In some embodiments, the network device 120 may receive RSRP feedback from the repeater 130-1. Alternatively, the network device 120 may receive RSRP feedback from the terminal device 110.

At block 870, the network device 120 chooses the beam pair with highest RSRP as the final one or the target one from set B. Alternatively, the network device 120 may choose the first beam pair with RSRP exceeding a threshold RSRP.

As mentioned above, the network device 120 may configure the set of reference signals for measuring self-interference. In some embodiments, the network device 120 may configure the set of reference signals to measure the self-interference for different angle differences or different beam pairs. In this case, in some embodiments, the network device 120 may receive measured self-interference signal strength from the repeater 130-1. Alternatively, the network device 120 may receive measured self-interference signal strength from the terminal device 110. The network device 120 may store the measured self-interference signal strength. The network device 120 may determine the final link for communication based on the stored results and quality of channel for different beam pairs. In some embodiments, if the self-interference signal strength is smaller than a predefined or preconfigured threshold, the network device 120 may determine the indication to indicate that applying the repeater 130-1 for building a communication.

In some embodiments, the predefined or preconfigured threshold may be determined based on the first SINR or SNR report by the repeater 130-1. Alternatively, the predefined or preconfigured threshold may be determined based on the second SINR or SNR report by the terminal device 110. Alternatively, the predefined or preconfigured threshold may be determined based on the second SINR or SNR report by the repeater 130-1 and the terminal device 110. In some other embodiments, the predefined or preconfigured threshold may be determined based on a transmission power of the repeater 130-1. In some embodiments, the predefined or preconfigured threshold may be determined based on a polarization direction of a receiving beam and a polarization direction of a transmitting beam. In some other embodiments, the predefined or preconfigured threshold may be determined based on beam width, number of beams, and number of antennas.

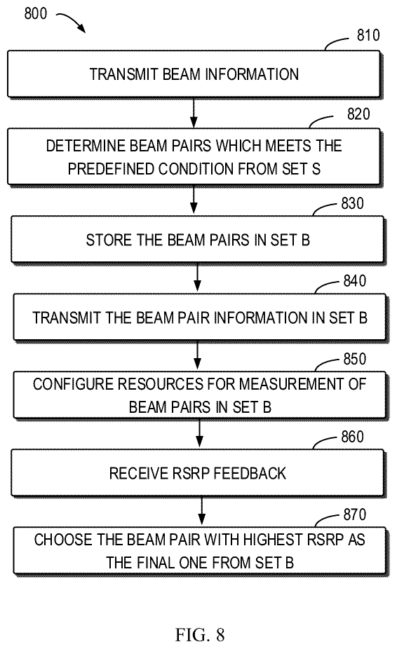

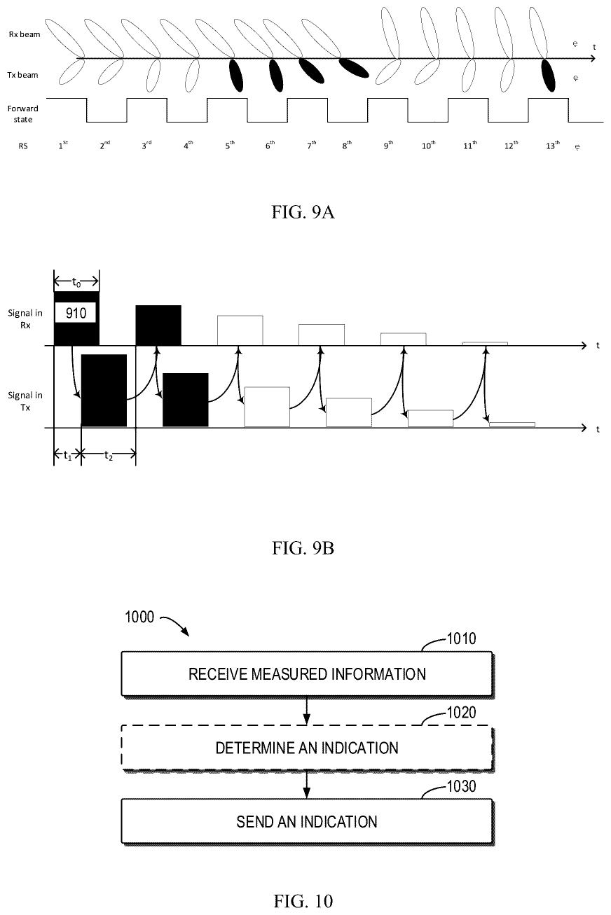

In some embodiments, the network device 120 may configure two repetitions of the set of reference signals for each beam pair at the repeater. In this case, the network device 120 may configure, to the repeater 130-1, a signaling to switch forward states for each beam pairs. For example, the signaling may comprise a start point and duration for each turn-off indication of forward module. Alternatively, the signaling may comprise a start point and an end point for each turn-off indication of forward module. The repeater 130-1 may switch the forwarding state to measure the strength difference of the received signal. For example, in some embodiment, if the repeater 130-1 enables forwarding module, the repeater 130-1 may measure the signal strength S1 in a first forward state. Enabling forward module means that the repeater 130-1 may forward the signal to the terminal device 110 via the transmitting beam when receiving signal from network device simultaneously. If the repeater 130-1 disables forwarding module, the repeater 130-1 may measure the signal strength S2 in a second forward state. Disabling forward module means that the repeater 130-1 may not forward the signal to the terminal device 110 while receiving module is receiving signal. In this case, the signal strength of self-interference may be derived by S1-S2 or other algorithms. For example, as shown in FIG. 9A, if the forward state is on, the repeater 130-1 may measure the first reference signal. If the forward state is off, the repeater 130-1 may measure the second reference signal.

In some embodiments, the network device 120 may transmit a pulse signal to the repeater 130-1. A duration of the pulse signal may be smaller than a sum delay of delay of the receiving signal transmitted to the transmitting module (denotes as t₁ in FIG. 9B), and the delay of transmission signal received in a receiver at the repeater 130-1(denoted as t₂ in FIG. 9B). For example, as shown in FIG. 9B, the duration t₀ of the pulse signal 910 may be not larger than the combination of t₁ and t₂, i.e., t₀≤t₁+t₂. In some embodiments, the pulse signal can be taken place by a sequence with well autocorrelation, and the length of the sequence can be decided by the delay of the sum delay of delay of the receiving signal transmitted to the transmitting module and the delay of transmission signal received in a receiver at the repeater 130-1, i.e., (tᵢ+t₂). In some embodiments, a sliding window can be used to compute the signal strength of the self-interference when sequence with well autocorrelation is used.

As mentioned above, the network device 120 may receive measured self-interference signal strength from the terminal device 110. The network device 120 may configure the terminal device 110 to measure the signal strength two times. In some embodiments, the two measurements may be indicated with two effective time independently. Alternatively, the first measurement may be indicated with an effective time, and the second measurement may be indicated with an offset from the first measurement.

In some embodiments, the network device 120 may transmit the set of reference signals to the repeater 130-1. The repeater 130-1 may transmit the set of reference signal to the terminal device 110 while receiving the reference signal from network device simultaneously. The terminal device 110 may measure the signal strength of the set of reference signal (S1). The terminal device 110 may inform the measured signal strength to the network device 120.

In some embodiments, the network device 120 may configure the repeater 130-1 to store the set of reference signals. In this case, the repeater 130-1 may store the set of reference signals. The network device 120 may configure the repeater 130-1 to transmit the reference signal with turn-off the receiving module. The repeater 130-1 may also transmit the stored set of reference signals to the terminal device 110 while disabling the receiving module. The terminal device 110 may measure the signal strength of the stored set of reference signal (S2). The terminal device 110 may inform the measured signal strength to the network device 120.

Alternatively, the repeater 130-1 may not store the set of reference signals. In this case, the network device 120 may transmit a configuration of the set of reference signals to the repeater 130-1. The repeater 130-1 may generate another set of reference signals based on the configuration of the set of reference signals. The repeater 130-1 may transmit the generated set of reference signals to the terminal device 110 while disabling the receiving module. The terminal device 110 may measure the signal strength of the generated set of reference signal (S2). The terminal device 110 may inform the measured signal strength to the network device 120.

In some embodiments, the terminal device 110 may determine the signal strength of self-interference based on S1 and S2, such as S1-S2. The terminal device 110 may inform the signal strength of self-interference to the network device 120. Alternatively, the network device 120 may determine the signal strength of self-interference based on S1 and S2, such as S1-S2.

Referring back to FIG. 2, the network device 120 transmits 2040 an indication to the repeater 130-1. The indication is used for indicating whether applying the repeater 130-1 for building the communication between the network device 120 and the terminal device 110.

In some embodiment, more than one repeater may be allocated for the network device 120 or a cell. For example, as shown in FIG. 1, the repeater 130-1 and the repeater 130-2 are located in the coverage of the network device 120. The network device 120 may select a target repeater from the repeaters based on the measured information of the repeaters. For example, the network device 120 may schedule the repeater to build communication based on all the measurements/reporting of the repeaters allocated within the coverage of the network device 120. In some embodiments, the network device 120 may choose the repeater for communication with lowest interference. The network device 120 may transmit the indication which indicates applying the target repeater to build the communication.

According to embodiments described with reference to FIG. 2, the network device can determine a proper repeater to build the communication, thereby avoiding low efficient scheduling of repeater.

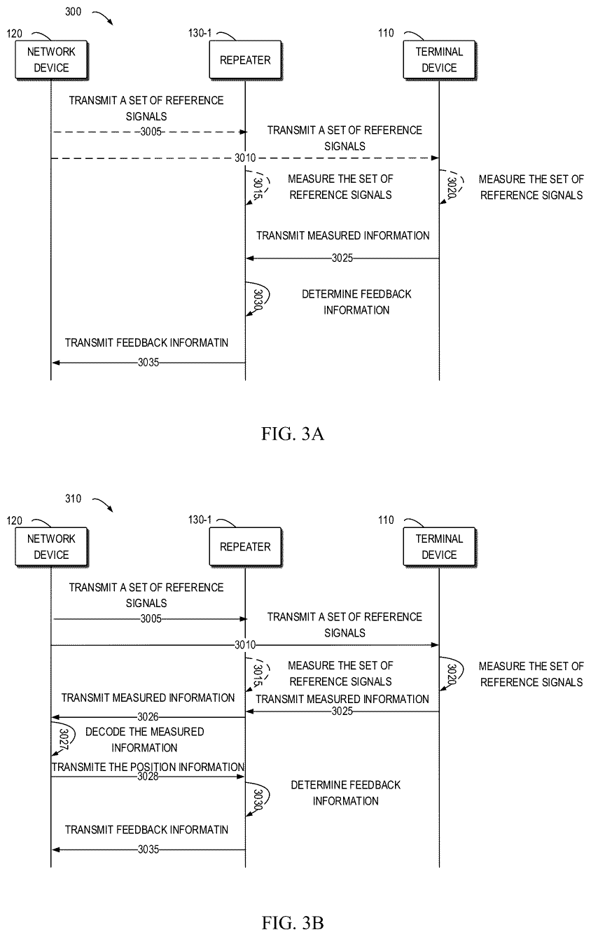

Embodiments of the present disclosure will be described in detail below. Reference is first made to FIG. 3A, which shows a signaling chart illustrating process 300 among the terminal device and the network device according to some example embodiments of the present disclosure. Only for the purpose of discussion, the process 300 will be described with reference to FIG. 1. The process 300 may be applied to a scenario where the repeater determines whether applying the repeater for building the communication between the network device and the terminal device.

The network device 120 may configure a set of reference signals for the terminal device 110 and the repeater 130-1. In some embodiments, the set of reference signals may be configured for measuring self-interference.

For example, the network device 120 may transmit 3005 the set of reference signals to the terminal device 110. The network device 120 may also transmit 3010 the set of reference signals to the repeater 130-1. In some embodiments, the set of reference signals may be a set of positioning reference signals. Alternatively, the set of reference signals may be a set of channel state information reference signals. It should be noted that the set of reference signals may be any proper signals. It should be noted that the order the transmission 3005 and the transmission 3010 shown in FIG. 3A is only an example. The transmission 3005 and the transmission 3010 may be performed simultaneously or in any proper order.

In some embodiments, the repeater 130-1 may measure 3015 the set of reference signals. For example, the repeater 130-1 may measure reference signal received power (RSRP) based on the set of reference signals. Alternately, the repeater 130-1 may measure signal to noise ratio (SNR) based on the set of reference signals. In some other embodiments, the repeater 130 may measure signal to interference and noise ratio (SINR) based on the set of reference signals.

In some embodiments, the terminal device 110 may measure 3020 the set of reference signals. For example, the terminal device 110 may measure RSRP based on the set of reference signals. Alternately, the terminal device 110 may measure SNR based on the set of reference signals. In some other embodiments, the terminal device 110 may measure SINR based on the set of reference signals. It should be noted that the order the measurement 3015 and the measurement 3020 shown in FIG. 3 is only an example. The measurement 3015 and the measurement 3020 may be performed simultaneously or in any proper order.

The terminal device 110 transmits 3025 measured information of the terminal device 110 to the repeater 130-1. In some embodiments, the measured information may comprise position information of the terminal device 110. Alternatively or in addition, the measured information may comprise angle information of the terminal device 110. For example, the angle information may comprise angle difference information. In some other embodiments, the measured information may comprise self-interference information of the repeater 130-1. The repeater 130-1 can decode the measured information received from the repeater 130-1.

The repeater 130-1 determines 3030 feedback information to report whether applying the repeater 130-1 for building the communication between the network device 120 and the terminal device 110. In some embodiments, the repeater 130-1 may determine whether one or more conditions associated with the repeater 130-1 are fulfilled based on the position information of the repeater 130-1 and the position information of the terminal device 120.

In some embodiment, the conditions may comprise a first condition where a first range between the network device 120 and the repeater 130-1 is smaller than a second range between the network device 120 and the terminal device 110. For example, as shown in FIG. 4, if the first range 410 is smaller than the second range 420, the repeater 130-1 may determine that the first condition is fulfilled.

Alternatively or in addition, the conditions may comprise a second condition where a first absolute value of a first angle between a first line and a second line is smaller than a first threshold value. The first line may be between the network device 120 and the terminal device 110 and the second line may be between the network device 120 and the repeater 130-1. In some embodiments, the first angle may be a vertical angle. Alternatively or in addition, the first angle may be an azimuth angle. If the first angle comprises the vertical angle and the azimuth angle, the first threshold value may also comprise a vertical threshold value and an azimuth angle threshold value. The angle can be measured based on global coordinate system (GCS), or local coordinate system (LCS). In the global coordinate system (GCS), estimated azimuth angle is measured relative to geographical North and is positive in a counter-clockwise direction and estimated vertical angle is measured relative to zenith and positive to horizontal direction. In the local coordinate system (LCS), estimated azimuth angle is measured relative to x-axis of LCS and positive in a counter-clockwise direction and estimated vertical angle is measured relative to z-axis of LCS and positive to x-y plane direction.

For example, as shown in FIG. 4, the first angle 430 can be represented as<UgR where U represents the terminal device 110, g represents the network device 120 and R represents the repeater 130-1. In other words, the first angle 430 can be the angle at the network device 120 with respect to the terminal device 110 and the repeater 130-1. In some embodiments, if the first absolute value of the first angle 430 is smaller than the first threshold value (for example, 90 degrees), the repeater 130-1 may determine that the second condition is fulfilled.

In some embodiments, the conditions may comprise a third condition where a second absolute value of a second angle between a third line and a fourth line is larger than a second threshold value. The third line may be between the repeater 130-1 and the network device 120. In other words, the third line and the second line can be the same. The fourth line may be between the repeater 130-1 and the terminal device 110. In some embodiments, the second angle may be a vertical angle. Alternatively or in addition, the second angle may be an azimuth angle. If the second angle comprises the vertical angle and the azimuth angle, the second threshold value may also comprise a vertical threshold value and an azimuth angle threshold value. The angle can be measured based on the GCS, or the LCS. In the GCS, estimated azimuth angle is measured relative to geographical North and is positive in a counter-clockwise direction and estimated vertical angle is measured relative to zenith and positive to horizontal direction. In the LCS, estimated azimuth angle is measured relative to x-axis of LCS and positive in a counter-clockwise direction and estimated vertical angle is measured relative to z-axis of LCS and positive to x-y plane direction.

For example, as shown in FIG. 4, the second angle 440 can be represented as<gRU, where U represents the terminal device 110, g represents the network device 120 and R represents the repeater 130-1. In other words, the second angle 440 can be the angle at the repeater 130-1 with respect to the network device 120 and the terminal device 110. In some embodiments, if the second absolute value of the second angle 440 is smaller than the second threshold value (for example, 45 degrees), the repeater 130-1 may determine that the third condition is fulfilled.

In some embodiments, if the first condition and the second condition are fulfilled, the repeater 130-1 may determine applying the repeater 130-1 for building the communication between the network device 120 and the terminal device 110-1. Alternatively or in addition, if the third condition and the second condition are fulfilled, the repeater 130-1 may determine applying the repeater 130-1 for building the communication between the network device 120 and the terminal device 110-1. Alternatively or in addition, if the third condition is fulfilled, the network device 120 may determine applying the repeater 130-1 for building the communication between the network device 120 and the terminal device 110-1. In some embodiments, for example, as shown in FIG. 5, if the repeater 130-1 is within the area 500, the repeater 130-1 may determine applying the repeater 130-1 for building the communication between the network device 120 and the terminal device 110-1.

In some embodiments, the position information of the repeater 130-1 may indicate the first range between the network device 120 and the repeater 130-1. For example, as shown in FIG. 4, the position information of the repeater 130-1 may directly indicate the first range 410.

Alternatively or in addition, the position information of the repeater 130-1 may indicate a third angle between a fifth line and a first reference line with a first direction. The fifth line may between the network device 120 and the repeater 130-1. In other words, the third line, the second line and the fifth line can be the same. The first reference line with the first direction may be configured by the network device 120. In some other embodiments, the position information of the terminal device 110 may indicate a fourth angle between a sixth line and a second reference line with a second direction. The sixth line may be between the terminal device 110 and the network device 120. The second reference line with the second direction may be configured by the network device 120. In some embodiments, the first reference line and the second reference line may be same. In this case, the network device 120 may determine the first angle based on the third angle and the fourth angle.

In some embodiments, the repeater 130-1 may determine the first range based on the position information of the repeater 130-1. For example, the repeater 130-1 may determine the first range 410 based on the position of the network device 120 and the position of the repeater 130-1. In this case, the position information of the repeater 130-1 may comprise coordinate values of the repeater 130-1 in a coordinate system. The repeater 130-1 may determine its coordinate values in the coordinate system. In this case, the first range may be determined based on the coordinate values.

In some embodiments, the repeater 130-1 may determine the second range based on the position information of the terminal device 110. For example, the repeater 130-1 may determine the second range 420 based on the position of the network device 120 and the position of the terminal device 110. In this case, the position information of the terminal device 110 may comprise coordinate values of the terminal device 110 in a coordinate system. The repeater 130-1 may determine the coordinate values of the network device 120 in the coordinate system. In this case, the second range may be determined based on the coordinate values.

In some other embodiments, the repeater 130-1 may determine the first angle based on the position information of the repeater 130-1 and the position information of the terminal device 110. The repeater 130-1 may determine the second angle based on the position information of the repeater 130-1 and the position information of the terminal device 110.

In some embodiments, the position information of the repeater 130-1 may be determined and stored by the network device 120 at the time of network planning. In some embodiments, the location of the repeater 130-1 may be fixed. In this case, the position information of the repeater 130-1 may be transmitted to the network device 120.

In some embodiments, the predefined condition for applying the repeater can be configured by the network device 120. For example, the predefined condition may comprise one or more of: an angle difference threshold, a polarization direction requirement, or beam width threshold. The predefined condition will be described in details later.

In this case, the repeater 130-1 may determine whether an angle difference between a receiving beam and a transmitting beam of the repeater 130-1 exceeds a first threshold angle based on the angle information of the repeater 130-1. If the angle difference exceeds the first threshold angle, the repeater 130-1 may determine applying the repeater 130-1 for building the communication between the network device 120 and the terminal device 110. In other words, the indication may be used to indicate that applying the repeater 130-1 for building the communication between the network device 120 and the terminal device 110. For example, as shown in FIG. 6, if the angle difference 610 between the receiving beam 620 and the transmitting beam 630 exceeds the first threshold angle, the repeater 130-1 may be applied for building the communication between the network device 120 and the terminal device 110.

In some embodiments, the angle information may be per beam pair. A beam pair may comprise a receiving beam and a transmitting beam. For example, if the repeater 130-1 has 4 receiving beams and 4 transmitting beams, there may be 16 beam pairs. In this case, the angle information may comprise angle information of the 16 beam pairs. The angle information may comprise one or more of a first angle difference in azimuth direction, a second angle difference in vertical direction, whether the receiving beam and the transmitting beam are in same or difference polarization direction. In some embodiments, the first angle difference may be based on a local coordinate system of the repeater 130-1 or a GCS. Alternatively or in addition, the second angle difference may be based on the local coordinate system of the repeater 130-1 or a GCS.

The first angle difference and/or the second angle difference may be indicated in quantized values in a range from a first angle to a second angle. For example, the reported value may be one of a quantized value from angle α₀ to angle α_{N}. In this case, α₀ is smaller than α_{N} and 2\hat{ }b values may be quantized. In some embodiments, if the angle difference is larger than a first predetermined value (α_{N}), this quantized value may not be reported. Alternatively, if the angle difference is smaller than a second predetermined value (α₀), an invalid value may be used by taking place of quantized value for reporting this case. In some embodiments, an reporting condition can be defined, for example, repeater reports the angle difference only when the angle difference is smaller than α_{N}, thereby decreasing complexity and payload of repeater to report the angle difference information. Alternatively, the angle difference smaller than α₀ is quantized as α₀. Alternatively, the angle difference is an absolute value.

In some embodiments, the angle information may be per beam. For example, if the repeater 130-1 has 4 receiving beams and 4 transmitting beams, the angle information may comprise angle information of the 8 beams. The angle information may indicate: a direction of the beam, a polarization of the beam. The beam may be a receiving beam (for example, the beam 620) or a transmission beam (for example, the beam 630). In some embodiments, the direction of the beam may comprise azimuth direction and/or vertical direction. In some embodiments, both directions may be angle information based on a coordinate system of each antenna panel at the repeater 130-1. Alternatively, both directions may be angle information based on a GCS.

In some embodiments, the first threshold angle may be a fixed value. For example, the first threshold αₜₕ may be fixed and not smaller than 90 degree. Alternatively, the first threshold angle may be determined based on a SINR or SNR reported by the repeater 130-1. In some embodiments, different angle differences may lead to different signal strength of self-interference for a same beam pair. Therefore, associating the angle threshold with SINR or SNR, maximizes the application of repeater when making sure the self-interference is negligible by comparing with noise power. Table 4 below shows an example relation between angle difference and self-interference where S₀>S₁>S₂, and α₀<α₁<α₂. It should be noted that Table 4 is only an example not limitation. Therefore, associating the angle threshold with SINR or SNR, maximizes the application of repeater when making sure the self-interference is negligible by comparing with noise power. For example, high SINR may correspond to high threshold angle (αₜₕ=α₂) and low SINR may correspond to low threshold angle (αₜₕ=α₀). The non-negligible strength of self-interference may increase with SINR.

TABLE 4

| Angle difference | Self-interference | SINR or SNR |
|---|---|---|
| \|α\| ≤ α₀ | S₀ | SNR₀ |
| α₀ < \|α\| ≤ α₁ | S₁ | SNR₁ |
| α₁ < \|α\| ≤ α₂ | S₂ | SNR₂ |

In some embodiments, the first threshold angle may be determined based on a SINR or SNR reported by the terminal device 110. The SINR reported by the terminal device 110 may correspond to whole link. Alternatively, the predefined or preconfigured threshold may be determined based on the second SINR or SNR report by the repeater 130-1 and the terminal device 110.

Alternatively, the first threshold angle may be determined based on a transmission power of the repeater 130-1. For example, different transmitted power may lead to different signal strength of self-interferences. For example, higher power may lead to larger signal strength of self-interference and lower power may lead to lower signal strength of self-interference. In this case, higher power may correspond to higher threshold angle and lower power may correspond to lower threshold angle.

In some embodiments, the first threshold angle may be determined based on a beam width of a beam of the repeater 130-1. The beam width may comprise the beam width of the receiving beam and/or the beam width of the transmitting beam. For example, different beam widths may lead to different self-interference under a same angle difference. The wider beam lead to larger angle range to introduce self-interference signal. In this case, wider beam may correspond to larger threshold angel, thereby avoiding self-interference.

In some other embodiments, the first threshold angle may be determined based on the number of beams at the repeater 130-1. For example, different number of beams may lead to different self-interference under a same angle difference. The number of beams may be associated with beam width. For example, more beams may lead to narrower beam and less beams may lead to wider beam. In this case, more beams or narrower beams may correspond to smaller threshold angel, thereby maximum the application area of repeater when avoiding self-interference or making sure the self-interference is negligible.

Alternatively, the first threshold angle may be determined based on the number of antennas at the repeater. For example, different antenna number may lead to different self-interference under a same angle difference. The number of antenna may be associated with beam width. For example, more antennas may lead to narrower beam and less antennas may lead to wider beam. In this case, more antennas may correspond to smaller threshold angle to maximum the application area of repeater when avoiding self-interference or making sure the self-interference is negligible.

Table 5 below shows an example relation among beam width, the number of beams, the number of antennas, and angle threshold, where αₜₕ_{₂}>aₜₕ_{₁}>aₜₕ_{₀}, θ₂>θ₁>θ₀, N₀>N₁>N₂, M₀>M₁>M₂. It should be noted that Table 5 is only an example not limitation.

TABLE 5

| | | | Threshold |
|---|---|---|---|
| Beam width | Number of beams | Number of antennas | Angle |
| θ_{3 dB} ≤ θ₀ | N₀ ≤ N_{beam} | M₀ ≤ Mₐₙₜ | αₜₕ_{₀} |
| θ₀ < θ_{3 dB} ≤ θ₁ | N₁ ≤ N_{beam} < N₀ | M₁ ≤ Mₐₙₜ < M₀ | αₜₕ_{₁} |
| θ₁ < θ_{3 dB} ≤ θ₂ | N₂ ≤ N_{beam} < N₁ | M₂ ≤ Mₐₙₜ < M₁ | αₜₕ_{₂} |

In some embodiments, the first threshold angle may be determined based on a polarization direction of a receiving beam and a polarization direction of a transmitting beam. For example, if the receiving beam and the transmitting beam have a same polarization direction, the first threshold may be represented as αₜₕ₁. If the receiving beam and the transmitting beam have different polarization directions, the first threshold may be represented as αₜₕ₂. In this case, the αₜₕ₁ may be larger than αₜₕ₂. Table 6 below shows an example relation among beam width, polarization direction, and threshold angle, where αₜₕ_{₅}>αₜₕ_{₄}>αₜₕ_{₃}>at >αₜₕ_{₁}>αₜₕ_{₀}, θ₂>θ₁>θ₀, N₀>N₁>N₂, M₀>M₁>M₂. It should be noted that Table 6 is only an example not limitation.

TABLE 6

| Polarization direction | Beam width | Threshold Angle |
|---|---|---|
| different | θ_{3 dB} ≤ θ₀ | αₜₕ_{₀} |
| | θ₀ < θ_{3 dB} ≤ θ₁ | αₜₕ_{₁} |
| | θ₁ < θ_{3 dB} ≤ θ₂ | αₜₕ_{₂} |
| same | θ_{3 dB} ≤ θ₀ | αₜₕ_{₃} |
| | θ₀ < θ_{3 dB} ≤ θ₁ | αₜₕ_{₄} |
| | θ₁ < θ_{3 dB} ≤ θ₂ | αₜₕ_{₅} |

Referring back to FIG. 3A, the repeater 130-1 transmits 3035 the feedback information to the network device 120. The feedback information is used for indicating whether applying the repeater 130-1 for building the communication between the network device 120 and the terminal device 110. For example, in some embodiments, if the feedback information comprises a bit indicating “0”, it means that the beam pair does not meet the condition. Alternatively, if the feedback information comprises a bit indicating “1”, it means that the beam pair meets the condition. In some embodiments, the feedback information may also comprise beam index or beam pair index. For example, a combined beam index of Rx beam and Tx beam in DL transmission can be used for beam pair indication. In some embodiments, the network device 120 may determine the final beam pair or target beam pair according to the reported feedback information and the reported RSRPs of the beam pairs. In this case, the network device 120 may transmit the final beam or target beam information to the repeater 130-1.

Embodiments of the present disclosure will be described in detail below. Reference is first made to FIG. 3B, which shows a signaling chart illustrating process 310 among the terminal device and the network device according to some example embodiments of the present disclosure. Only for the purpose of discussion, the process 310 will be described with reference to FIG. 1. The process 310 may be applied to a scenario where the repeater determines whether applying the repeater for building the communication between the network device and the terminal device.

The network device 120 may configure a set of reference signals for the terminal device 110 and the repeater 130-1. In some embodiments, the set of reference signals may be configured for measuring self-interference.

For example, the network device 120 may transmit 3010 the set of reference signals to the terminal device 110. The network device 120 may also transmit 3005 the set of reference signals to the repeater 130-1. In some embodiments, the set of reference signals may be a set of positioning reference signals. Alternatively, the set of reference signals may be a set of channel state information reference signals. It should be noted that the set of reference signals may be any proper signals. It should be noted that the order the transmission 3005 and the transmission 3010 shown in FIG. 3B is only an example. The transmission 3005 and the transmission 3010 may be performed simultaneously or in any proper order.

In some embodiments, the repeater 130-1 may measure 3015 the set of reference signals. For example, the repeater 130-1 may measure reference signal received power (RSRP) based on the set of reference signals. Alternately, the repeater 130-1 may measure signal to noise ratio (SNR) based on the set of reference signals. In some other embodiments, the repeater 130 may measure signal to interference and noise ratio (SINR) based on the set of reference signals.

In some embodiments, the terminal device 110 may measure 3020 the set of reference signals. For example, the terminal device 110 may measure RSRP based on the set of reference signals. Alternately, the terminal device 110 may measure SNR based on the set of reference signals. In some other embodiments, the terminal device 110 may measure SINR based on the set of reference signals. It should be noted that the order the measurement 3015 and the measurement 3020 shown in FIG. 3B is only an example. The measurement 3015 and the measurement 3020 may be performed simultaneously or in any proper order.

In some embodiments, the repeater 130-1 cannot decode the measured information transmitted from terminal device 110, the repeater 130-1 may transmit 3026 the measured information from terminal device 110 to the network device 120. The network device 120 may decode 3027 the measured information. In this case, the network device 120 may transmit 3028 the position information of the terminal device 110 to the repeater 130-1.

The repeater 130-1 determines 3030 feedback information to report whether applying the repeater 130-1 for building the communication between the network device 120 and the terminal device 110. In some embodiments, the repeater 130-1 may determine whether one or more conditions associated with the repeater 130-1 are fulfilled based on the position information of the repeater 130-1 and the position information of the terminal device 120. The determination 3030 of the feedback information shown in FIG. 3B can be the same as the determination 3030 of the feedback information shown in FIG. 3A, which will not be described for clarity.

Referring back to FIG. 3B, the repeater 130-1 transmits 3035 the feedback information to the network device 120. The feedback information is used for indicating whether applying the repeater 130-1 for building the communication between the network device 120 and the terminal device 110. For example, in some embodiments, if the feedback information comprises a bit indicating “0”, it means that the beam pair does not meet the condition. Alternatively, if the feedback information comprises a bit indicating “1”, it means that the beam pair meets the condition. In some embodiments, the feedback information may also comprise beam index or beam pair index. For example, a combined beam index of Rx beam and Tx beam in DL transmission can be used for beam pair indication. In some embodiments, the network device 120 may determine the final beam pair or target beam pair according to the reported feedback information and the reported RSRPs of the beam pairs. In this case, the network device 120 may transmit the final beam or target beam information to the repeater 130-1.

According to embodiments described with reference to FIGS. 3A and 3B, the repeater can determine whether the repeater can be used to build the communication, thereby avoiding low efficient scheduling of repeater. Moreover, it can also save overhead, since less information needs to be transmitted.

FIG. 10 shows a flowchart of an example method 1000 in accordance with an embodiment of the present disclosure. The method 1000 can be implemented at any suitable terminal devices. Only for the purpose of illustrations, the method 1000 can be implemented at the network device 120 shown in FIG. 1. The method 1000 is a generic process. Details of embodiments are described later.

At block 1010, the network device receives measured information from a repeater. The measured information comprises at least one of: position information of the repeater, angle information of the repeater, or self-interference information of the repeater.

In some embodiments, at block 1020, the network device determines an indication of the repeater. The indication is used for indicating whether applying the repeater for building a communication between the network device and the terminal device based at least on the measured information. In some embodiments, the network device may receive position information of the terminal device from the terminal device. In this case, the network device may determine whether one or more conditions associated with the repeater are fulfilled based on the position information of the repeater and the position information of the terminal device.

In some embodiments, the one or more conditions comprises at least one of: a first condition where a first range between the network device and the repeater is smaller than a second range between the network device and the terminal device, a second condition where a first absolute value of a first angle between a first line and a second line is smaller than a first threshold value, wherein the first line is between the network device and the terminal device and the second line is between the network device and the repeater, or a third condition where a second absolute value of a second angle between a third line and a fourth line is larger than a second threshold value, wherein the third line is between the repeater and the network device and the fourth line is between the repeater and the terminal device.

In some embodiments, the network device may determine the indication to indicate applying the repeater for building the communication, if the first and second conditions are fulfilled or the second and third conditions are fulfilled. The position information of the repeater indicates at least one of: the first range between the network device and the repeater, a third angle between a third line and a first reference line with a first direction, wherein the third line is between the network device and the repeater, a fourth angle between a fourth line and a second reference line with a second direction, wherein the fourth line is between the terminal device and the repeater, and the position information of the terminal device indicates the second range. Alternatively, the network device may perform at least one of determining the first range based on the position information of the repeater; determining the second range based on the position information of the terminal device; determining the first angle based on the position information of the repeater and the position information of the terminal device; or determining the second angle based on the position information of the repeater and the position information of the terminal device.

In some embodiments, the network device may determine whether an angle difference between a receiving beam and a transmitting beam of the repeater exceeds a first threshold angle based on the angle information of the repeater. If the angle difference exceeds the first threshold angle, In some embodiments, the network device may determine the indication to indicate that applying the repeater for building the communication between the network device and the terminal device.

In some embodiments, for each beam pair comprising a receiving beam and a transmitting beam, the angle information indicates at least one of: a first angle difference in azimuth direction, a second angle difference in vertical direction, whether the receiving beam and the transmitting beam are in same or difference polarization direction. The first angle difference and the second angle difference may be determined based on a local coordinate system of the repeater or a global coordinate system (GCS). The first angle difference and the second angle difference may be indicated in quantized values in a range from a first angle to a second angle.

In some embodiments, for each beam, the angle information indicates: a direction of the beam, a polarization of the beam. The beam may be a receiving beam or a transmission beam. The direction of the beam may comprise at least one of: an azimuth direction or a vertical direction, both the azimuth and vertical directions are angle information based on a coordinate system of each antenna panel at the repeater or based on a GCS.

In some embodiments, the first threshold angle is determined based on at least one of: a first signal to interference and noise ratio (SINR) or signal to noise ratio SNR report by the repeater, a second SINR or SNR report by the terminal device, a transmission power of the repeater, a beam width at the repeater, the number of beams at the repeater, the number of antennas at the repeater, or a polarization direction of a receiving beam and a polarization direction of a transmitting beam.

In some embodiments, the network device may receive, from the repeater, beam information of beam pairs at the repeater. Alternatively or in addition, the network device may receive, from the repeater, reference signal received power (RSRP) information of the beam pairs. In some embodiments, the network device may determine whether a target beam pair meets an angle difference condition based on the beam information. In some embodiments, the network device may determine whether a target beam pair meets a RSRP condition based on the RSRP information. If a target beam pair meets the angle difference condition and the RSRP condition, the network device may determine the target beam pair for building the communication.

In some embodiments, the RSRP information may indicate RSRPs of all beam pairs. Alternatively, the RSRP information may indicate RSRPs of a set of beam pairs which fulfills the angle difference condition. In some embodiments, the network device may transmit, to the repeater, beam information of the set of beam pairs.

In some embodiments, the network device may configure a set of reference signals for measure self-interference. The network device may receive measured self-interference signal strength from the repeater or a terminal device. In some embodiments, if the self-interference signal strength is smaller than a predefined or preconfigured threshold, the network device may determine the indication to indicate that applying the repeater for building the communication.

In some embodiments, the predefined or preconfigured threshold is determined based on at least one of: a first SINR or SNR report by the repeater, a second SINR or SNR report by the terminal device, a transmission power of the repeater, or a polarization direction of a receiving beam and a polarization direction of a transmitting beam.

In some embodiments, the network device may perform one or more of: configuring, to the repeater, two repetitions of the set of reference signals for each beam pair at the repeater; configuring, to the repeater, a signaling to switch forward states for each beam pairs; or transmitting a pulse signal, wherein a duration of the pulse signal is smaller than a delay of transmitting signal received in a receiver at the repeater.

At block 1030, the network device sends the indication to the repeater. In some embodiments, the repeater and another repeater may locate in a coverage of the network device. In this case, the network device may select a target repeater from the repeater and the other repeater based on the measured information of the repeater and other measured information of the other repeater. The network device may send the indication indicating applying the target repeater among the repeater and the other repeater to build the communication.

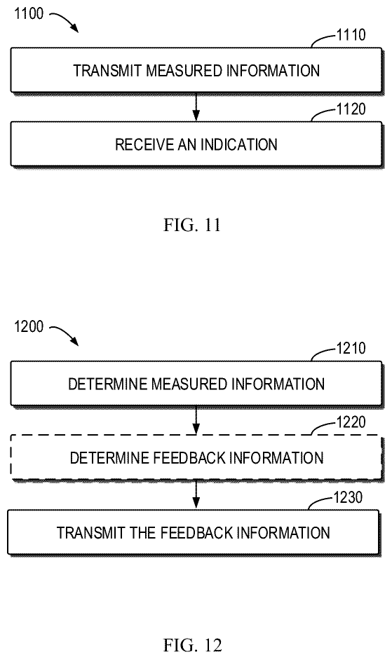

FIG. 11 shows a flowchart of an example method 1100 in accordance with an embodiment of the present disclosure. The method 1100 can be implemented at any suitable terminal devices. Only for the purpose of illustrations, the method 1100 can be implemented at the repeater 130 shown in FIG. 1. The method 1100 is a generic process. Details of embodiments are described later.

At block 1110, the repeater transmits measured information to the network device. The measured information comprises at least one of: position information of the repeater, angle information of the repeater, or self-interference information of the repeater.

In some embodiments, for each beam pair comprising a receiving beam and a transmitting beam, the angle information indicates at least one of: a first angle difference in azimuth direction, a second angle difference in vertical direction, whether the receiving beam and the transmitting beam are in same or difference polarization direction. The first angle difference and the second angle difference may be determined based on a local coordinate system of the repeater or a global coordinate system (GCS). The first angle difference and the second angle difference may be indicated in quantized values in a range from a first angle to a second angle.

In some embodiments, for each beam, the angle information indicates: a direction of the beam, a polarization of the beam, wherein the beam is a receiving beam or a transmission beam. The direction of the beam may comprise at least one of: an azimuth direction or a vertical direction, both the azimuth and vertical directions may be angle information based on a coordinate system of each antenna panel at the repeater, or based on a GCS.

In some embodiments, the repeater may receive a set of reference signals from the network device. In this case, the repeater may measure the signal strength based on the set of reference signals in a first forward state and measure the signal strength based on the set of reference signals in a second forwards state.

In some embodiments, the repeater may receive a set of reference signals from the network device while transmitting the set of reference signals to the terminal device simultaneously. The repeater may store the set of reference signals at the repeater. In this case, the repeater may transmit the stored set of reference signals to the terminal device. The repeater may disable the receiving module at the same time.

In some embodiments, the repeater may receive receiving a set of reference signals from the network device while transmitting the set of reference signals to the terminal device. The repeater may receive a configuration of the set of reference signals from the network device. The repeater may generate another set of reference signals based on the configuration of the set of reference signals. In this case, the repeater may transmit the generated set of reference signals to the terminal device.

At block 1120, the repeater receives an indication from the network device. The indication is used for indicating whether applying the repeater for building a communication between the network device and the terminal device.

FIG. 12 shows a flowchart of an example method 1200 in accordance with an embodiment of the present disclosure. The method 1200 can be implemented at any suitable terminal devices. Only for the purpose of illustrations, the method 1200 can be implemented at the repeater 130 shown in FIG. 1. The method 1200 is a generic process. Details of embodiments are described later.

At block 1210, the repeater determines measured information. The measured information comprises at least one of: position information of the repeater, angle information of the repeater, or self-interference information of the repeater.

In some embodiments, at block 1220, the repeater determines feedback information to report whether applying the repeater for building a communication between the network device and the terminal device based at least on the measured information.

In some embodiments, the repeater may receive position information of the terminal device from the network device. The repeater may determine whether one or more conditions associated with the repeater are fulfilled based on the position information of the repeater and the position information of the terminal device. In some embodiments, the one or more conditions comprises at least one of: a first condition where a first range between the network device and the repeater is smaller than a second range between the network device and the terminal device, a second condition where a first absolute value of a first angle between a first line and a second line is smaller than a first threshold value, wherein the first line is between the network device and the terminal device and the second line is between the network device and the repeater, or a third condition where a second absolute value of a second angle between a third line and a fourth line is larger than a second threshold value, wherein the third line is between the repeater and the network device and the fourth line is between the repeater and the terminal device.

In some embodiments, the repeater may determine the feedback information to report applying the repeater for building the communication, if the first and second conditions are fulfilled or the second and third conditions are fulfilled.

In some embodiments, the position information of the repeater indicates at least one of: the first range between the network device and the repeater, a third angle between a third line and a first reference line with a first direction, wherein the third line is between the network device and the repeater, a fourth angle between a fourth line and a second reference line with a second direction, wherein the fourth line is between the terminal device and the repeater, and the position information of the terminal device indicates the second range. Alternatively, in some embodiments, the repeater may perform one or more of: determining the first range based on the position information of the repeater; determining the second range based on the position information of the terminal device; determining the first angle based on the position information of the repeater and the position information of the terminal device; or determining the second angle based on the position information of the repeater and the position information of the terminal device.

In some embodiments, the repeater may receive a set of conditions regarding the angle difference from the network device. In this case, the repeater may determine whether a set of beam pairs satisfy one or more conditions in the set of conditions. The repeater may transmit to the network device a result of the determination and indexes of beam pairs in the set of beam pairs. The repeater may also receive from the network device an indication of a selected beam pair in the set of beam pairs.

In some embodiments, the set of conditions comprises at least one of: a first condition where a first range between the network device and the repeater is smaller than a second range between the network device and the terminal device, a second condition where a first absolute value of a first angle between a first line and a second line is smaller than a first threshold value, wherein the first line is between the network device and the terminal device and the second line is between the network device and the repeater, a third condition where a second absolute value of a second angle between a third line and a fourth line is larger than a second threshold value, wherein the third line is between the repeater and the network device and the fourth line is between the repeater and the terminal device, a first threshold angle, a predefined or preconfigured signal strength threshold, a first signal to interference and noise ratio (SINR) or signal to noise ratio SNR report by the repeater, a second SINR or SNR report by the terminal device, a transmission power of the repeater, a beam width at the repeater, the number of beams at the repeater, the number of antennas at the repeater, or a polarization direction of a receiving beam and a polarization direction of a transmitting beam.

At block 1230, the repeater transmits, to the network device, the feedback information.

In some embodiments, a network device comprises circuitry configured to perform: receiving measured information from a repeater, wherein the measured information comprises at least one of position information of the repeater, angle information of the repeater, or self-interference information of the repeater; and sending an indication to the repeater, the indication being used for indicating whether applying the repeater for building a communication between the network device and a terminal device based at least on the measured information.

In some embodiments, the network device comprises circuitry configured to perform: receiving, from the terminal device, position information of the terminal device; and determining whether one or more conditions associated with the repeater are fulfilled based on the position information of the repeater and the position information of the terminal device.

In some embodiments, the one or more conditions comprises at least one of: a first condition where a first range between the network device and the repeater is smaller than a second range between the network device and the terminal device, a second condition where a first absolute value of a first angle between a first line and a second line is smaller than or equal to a first threshold value, wherein the first line is between the network device and the terminal device and the second line is between the network device and the repeater, or a third condition where a second absolute value of a second angle between a third line and a fourth line is larger than or equal to a second threshold value, wherein the third line is between the repeater and the network device and the fourth line is between the repeater and the terminal device.

In some embodiments, the network device comprises circuitry configured to perform: in accordance with a determination that the first and second conditions are fulfilled or the second and third conditions are fulfilled, determining the indication to indicate applying the repeater for building the communication.

In some embodiments, the position information of the repeater indicates at least one of: the first range between the network device and the repeater, a third angle between a fifth line and a first reference line with a first direction, wherein the fifth line is between the network device and the repeater, the position information of the terminal device indicates the second range, or a fourth angle between a sixth line and a second reference line with a second direction, wherein the sixth line is between terminal device and the network device.

In some embodiments, the network device comprises circuitry configured to perform: determining whether an angle difference between a spatial domain receive filter and a spatial domain transmission filer of the repeater exceeds a first threshold angle based on the angle information of the repeater; and in accordance with a determination that the angle difference exceeds the first threshold angle, determining the indication to indicate that applying the repeater for building the communication between the network device and the terminal device.

In some embodiments, for each spatial domain filter pair comprising a spatial domain receive filter and a spatial domain transmission filter, the angle information indicates at least one of: a first angle difference in azimuth direction, a second angle difference in vertical direction, whether the spatial domain receive filter and the spatial domain transmission filter are in same or difference polarization direction, wherein the first angle difference and the second angle difference are determined based on a local coordinate system of the repeater or a global coordinate system (GCS), and wherein the first angle difference and the second angle difference are indicated in quantized values in a range from a first angle to a second angle.

In some embodiments, for each spatial domain filter, the angle information indicates: a direction of the spatial domain filter, a polarization of the spatial domain filter, wherein the spatial domain filter is a spatial domain receive filter or a spatial domain transmission filter, and wherein the direction of the spatial domain filter comprises at least one of: an azimuth direction or a vertical direction, both the azimuth and vertical directions are angle information based on a coordinate system of each antenna panel at the repeater or based on a GCS.

In some embodiments, the first threshold angle is determined based on at least one of: a first signal to interference and noise ratio (SINR) or signal to noise ratio SNR report by the repeater, a second SINR or SNR report by the terminal device, a transmission power of the repeater, a spatial domain filter width at the repeater, the number of spatial domain filters at the repeater, the number of antennas at the repeater, or a polarization direction of a spatial domain receive filter and a polarization direction of a spatial domain transmission filter.

In some embodiments, the network device comprises circuitry configured to perform: receiving, from the repeater, spatial domain filter information of spatial domain filter pairs at the repeater; receiving, from the repeater, reference signal received power (RSRP) information of the spatial domain filter pairs; determining whether a target spatial domain filter pair meets an angle difference condition based on the spatial domain filer information; determining whether the target spatial domain filter pair meets a RSRP condition based on the RSRP information; and in accordance with a determination that the target spatial domain filter pair meets the angle difference condition and the RSRP condition, selecting the target spatial domain filter pair for building the communication.

In some embodiments, the RSRP information indicates RSRPs of all spatial domain filter pairs, or the RSRP information indicates RSRPs of a set of spatial domain filter pairs which fulfills the angle difference condition. In some embodiments, the network device comprises circuitry configured to perform: transmitting, to the repeater, spatial domain filter information of the set of spatial domain filter pairs.

In some embodiments, the network device comprises circuitry configured to perform: configuring a set of reference signals; receiving measured self-interference signal strength from the repeater or the terminal device; and in accordance with a determination that the self-interference signal strength is smaller than a predefined or preconfigured threshold, determining the indication to indicate that applying the repeater for building the communication.

In some embodiments, the predefined or preconfigured threshold is determined based on at least one of: a first SINR or SNR report by the repeater, a second SINR or SNR report by the terminal device, a transmission power of the repeater, or a polarization direction of a spatial domain receive filter and a polarization direction of a spatial domain transmission filter.

In some embodiments, the network device comprises circuitry configured to perform at least one of: configuring, to the repeater, two repetitions of the set of reference signals for each spatial domain filer pair at the repeater; configuring, to the repeater, a signaling to switch forward states for each spatial domain filter pairs; or transmitting a pulse signal, wherein a duration of the pulse signal is smaller than or equal to a sum delay of a delay of receiving signal transmitted to a transmitting module at the repeater and a delay of transmitting signal received in a receiver at the repeater.

In some embodiments, the repeater and another repeater locate in a coverage of the network device. In some embodiments, the network device comprises circuitry configured to perform: selecting a target repeater from the repeater and the other repeater based on the measured information of the repeater and other measured information of the other repeater; and sending the indication indicating applying the target repeater among the repeater and the other repeater to build the communication.

In some embodiments, a repeater device circuitry configured to perform: transmitting measured information to a network device, wherein the measured information comprises at least one of: position information of the repeater, angle information of the repeater, or self-interference information of the repeater; and receiving an indication from the network device, the indication being used for indicating whether applying the repeater for building a communication between the network device and a terminal device.

In some embodiments, for each spatial domain filter pair comprising a spatial domain receive filter and a spatial domain transmission filter, the angle information indicates at least one of: a first angle difference in azimuth direction, a second angle difference in vertical direction, whether the spatial domain receive filter and the spatial domain transmission filter are in same or difference polarization direction, wherein the first angle difference and the second angle difference are determined based on a local coordinate system of the repeater or a global coordinate system (GCS), and wherein the first angle difference and the second angle difference are indicated in quantized values in a range from a first angle to a second angle.

In some embodiments, for each spatial domain filter, the angle information indicates: a direction of the spatial domain filter, a polarization of the spatial domain filter, wherein the spatial domain filter is a spatial domain receive filter or a spatial domain transmission filter, and wherein the direction of the spatial domain filter comprises at least one of: an azimuth direction or a vertical direction, both the azimuth and vertical directions are angle information based on a coordinate system of each antenna panel at the repeater, or based on a GCS.

In some embodiments, the repeater device circuitry configured to perform: receiving a set of reference signals from the network device; measuring the signal strength based on the set of reference signals in a first forward state; and measuring the signal strength based on the set of reference signals in a second forwards state.

In some embodiments, the repeater device circuitry configured to perform: receiving a set of reference signals from the network device; transmitting the set of reference signals to the terminal device simultaneously; storing the set of reference signals at the repeater; transmitting the stored set of reference signals to the terminal device; and disabling the receiving module at the same time.

In some embodiments, the repeater device circuitry configured to perform: receiving a set of reference signals from the network device; transmitting the set of reference signals to the terminal device simultaneously; receiving a configuration of the set of reference signals from the network device; generating another set of reference signals based on the configuration of the set of reference signals; transmitting the generated set of reference signals to the terminal device.

In some embodiments, a repeater device circuitry configured to perform: determining, at a repeater, measured information, wherein the measured information comprises at least one of: position information of the repeater, angle information of the repeater, or self-interference information of the repeater; and transmitting, to the network device, a feedback information to report whether applying the repeater for building a communication between the network device and the terminal device based at least on the measured information.

In some embodiments, the repeater device circuitry configured to perform: receiving, from the network device, position information of the terminal device. In some embodiments, the repeater device circuitry configured to perform: determining whether one or more conditions associated with the repeater are fulfilled based on the position information of the repeater and the position information of the terminal device.

In some embodiments, the one or more conditions comprises at least one of: a first condition where a first range between the network device and the repeater is smaller than a second range between the network device and the terminal device, a second condition where a first absolute value of a first angle between a first line and a second line is smaller than or equal to a first threshold value, wherein the first line is between the network device and the terminal device and the second line is between the network device and the repeater, or a third condition where a second absolute value of a second angle between a third line and a fourth line is larger than or equal to a second threshold value, wherein the third line is between the repeater and the network device and the fourth line is between the repeater and the terminal device.

In some embodiments, the repeater device circuitry configured to perform: in accordance with a determination that the first and second conditions are fulfilled or the second and third conditions are fulfilled, determining the feedback information to report applying the repeater for building the communication.

In some embodiments, the position information of the terminal device indicates at least one of: the first range between the network device and the repeater, a third angle between a fifth line and a first reference line with a first direction, wherein the fifth line is between the network device and the repeater, the position information of the terminal device indicates the second range, or a fourth angle between a sixth line and a second reference line with a second direction, wherein the sixth line is between terminal device and the network device.

In some embodiments, the repeater device circuitry configured to perform: receiving, from the network device, a set of conditions regarding the angle difference; determining whether a set of spatial domain filter pairs satisfy one or more conditions in the set of conditions; transmitting to the network device a result of the determination and indexes of spatial domain filter pairs in the set of spatial domain filter pairs; and receiving from the network device an indication of a selected spatial domain filter pair in the set of spatial domain filter pairs.

In some embodiments, the set of conditions comprises at least one of: a first threshold angle, a predefined or preconfigured signal strength threshold, a first signal to interference and noise ratio (SINR) or signal to noise ratio SNR report by the repeater, a second SINR or SNR report by the terminal device, a transmission power of the repeater, a spatial domain filter width at the repeater, the number of spatial domain filters at the repeater, the number of antennas at the repeater, or a polarization direction of a spatial domain receive filter and a polarization direction of a spatial domain transmission filter.

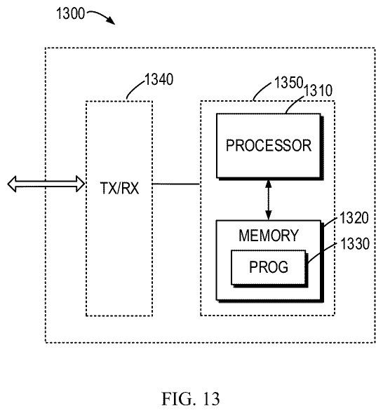

FIG. 13 is a simplified block diagram of a device 1300 that is suitable for implementing embodiments of the present disclosure. The device 1300 can be considered as a further example implementation of the terminal devices 110 as shown in FIGS. 1A and 1B. Accordingly, the device 1300 can be implemented at or as at least a part of the terminal device 110-1 or the terminal device 110-2.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1320 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1330 is assumed to include program instructions that, when executed by the associated processor 1310, enable the device 1300 to operate in accordance with the embodiments of the present disclosure, as discussed herein with reference to FIG. 4 to 11. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 4 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space bome vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz(THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1. A communication method, comprising:
transmitting, at a repeater, measured information to a network device, wherein the measured information comprises at least one of:
position information of the repeater,
angle information of the repeater, or
self-interference information of the repeater; and
receiving an indication from the network device, the indication being used for indicating whether applying the repeater for building a communication between the network device and a terminal device.

2. The method of claim 1, wherein for each spatial domain filter pair comprising a spatial domain receive filter and a spatial domain transmission filter, the angle information indicates at least one of: a first angle difference in azimuth direction, a second angle difference in vertical direction, whether the spatial domain receive filter and the spatial domain transmission filter are in same or difference polarization direction,
wherein the first angle difference and the second angle difference are determined based on a local coordinate system of the repeater or a global coordinate system (GCS), and
wherein the first angle difference and the second angle difference are indicated in quantized values in a range from a first angle to a second angle.

3. The method of claim 1, wherein for each spatial domain filter, the angle information indicates: a direction of the spatial domain filter, a polarization of the spatial domain filter, wherein the spatial domain filter is a spatial domain receive filter or a spatial domain transmission filter, and
wherein the direction of the spatial domain filter comprises at least one of: an azimuth direction or a vertical direction, both the azimuth and vertical directions are angle information based on a coordinate system of each antenna panel at the repeater, or based on a GCS.

4. A communication method, comprising:
determining, at a repeater, measured information, wherein the measured information comprises at least one of:
position information of the repeater,
angle information of the repeater, or
self-interference information of the repeater; and
transmitting, to the network device, feedback information to report whether applying the repeater for building a communication between the network device and the terminal device based at least on the measured information.

5. The method of claim 4, further comprising:
receiving, from the network device, position information of the terminal device; and
wherein the method further comprises:
determining whether one or more conditions associated with the repeater are fulfilled based on the position information of the repeater and the position information of the terminal device.

6. The method of claim 5, further comprising:
in accordance with a determination that the first and second conditions are fulfilled or the second and third conditions are fulfilled, determining the feedback information to report applying the repeater for building the communication.

7. The method of claim 5, wherein the position information of the terminal device indicates at least one of:
the first range between the network device and the repeater,
a third angle between a fifth line and a first reference line with a first direction, wherein the fifth line is between the network device and the repeater,
the position information of the terminal device indicates the second range, or
a fourth angle between a sixth line and a second reference line with a second direction, wherein the sixth line is between terminal device and the network device.

8. The method of claim 4, further comprising:
receiving, from the network device, a set of conditions regarding the angle difference;
determining whether a set of spatial domain filter pairs satisfy one or more conditions in the set of conditions;
transmitting to the network device a result of the determination and indexes of spatial domain filter pairs in the set of spatial domain filter pairs; and
receiving from the network device an indication of a selected spatial domain filter pair in the set of spatial domain filter pairs.

9. The method of claim 8, wherein the set of conditions comprises at least one of:
a first threshold angle,
a predefined or preconfigured signal strength threshold,
a first signal to interference and noise ratio (SINR) or signal to noise ratio SNR report by the repeater,
a second SINR or SNR report by the terminal device,
a transmission power of the repeater,
a spatial domain filter width at the repeater,
the number of spatial domain filters at the repeater,
the number of antennas at the repeater, or
a polarization direction of a spatial domain receive filter and a polarization direction of a spatial domain transmission filter.

10. A communication method, comprising:
receiving, at a network device, measured information from a repeater, wherein the measured information comprises at least one of:
position information of the repeater,
angle information of the repeater, or
self-interference information of the repeater; and
sending an indication to the repeater, the indication being used for indicating whether applying the repeater for building a communication between the network device and a terminal device based at least on the measured information.

11. The method of claim 10, wherein the position information of the repeater indicates at least one of:
the first range between the network device and the repeater,
a third angle between a fifth line and a first reference line with a first direction, wherein the fifth line is between the network device and the repeater,
the position information of the terminal device indicates the second range, or
a fourth angle between a sixth line and a second reference line with a second direction, wherein the sixth line is between terminal device and the network device.

12. The method of claim 10, further comprising
determining whether an angle difference between a spatial domain receive filter and a spatial domain transmission filer of the repeater exceeds a first threshold angle based on the angle information of the repeater; and
in accordance with a determination that the angle difference exceeds the first threshold angle, determining the indication to indicate that applying the repeater for building the communication between the network device and the terminal device.

13. The method of claim 10, wherein for each spatial domain filter pair comprising a spatial domain receive filter and a spatial domain transmission filter, the angle information indicates at least one of: a first angle difference in azimuth direction, a second angle difference in vertical direction, whether the spatial domain receive filter and the spatial domain transmission filter are in same or difference polarization direction,
wherein the first angle difference and the second angle difference are determined based on a local coordinate system of the repeater or a global coordinate system (GCS), and
wherein the first angle difference and the second angle difference are indicated in quantized values in a range from a first angle to a second angle.

14. The method of claim 10, wherein for each spatial domain filter, the angle information indicates: a direction of the spatial domain filter, a polarization of the spatial domain filter, wherein the spatial domain filter is a spatial domain receive filter or a spatial domain transmission filter, and
wherein the direction of the spatial domain filter comprises at least one of: an azimuth direction or a vertical direction, both the azimuth and vertical directions are angle information based on a coordinate system of each antenna panel at the repeater or based on a GCS.

15. The method of claim 12, wherein the first threshold angle is determined based on at least one of:
a first signal to interference and noise ratio (SINR) or signal to noise ratio SNR report by the repeater,
a second SINR or SNR report by the terminal device,
a transmission power of the repeater,
a spatial domain filter width at the repeater,
the number of spatial domain filters at the repeater,
the number of antennas at the repeater, or
a polarization direction of a spatial domain receive filter and a polarization direction of a spatial domain transmission filter.

16. The method of claim 10, further comprising:
receiving, from the repeater, spatial domain filter information of spatial domain filter pairs at the repeater;
receiving, from the repeater, reference signal received power (RSRP) information of the spatial domain filter pairs;
determining whether a target spatial domain filter pair meets an angle difference condition based on the spatial domain filer information;
determining whether the target spatial domain filter pair meets a RSRP condition based on the RSRP information; and
in accordance with a determination that the target spatial domain filter pair meets the angle difference condition and the RSRP condition, selecting the target spatial domain filter pair for building the communication.

17. The method of claim 16, wherein the RSRP information indicates RSRPs of all spatial domain filter pairs, or
wherein the RSRP information indicates RSRPs of a set of spatial domain filter pairs which fulfills the angle difference condition, and
wherein the method further comprises:
transmitting, to the repeater, spatial domain filter information of the set of spatial domain filter pairs.

18. The method of claim 10, further comprising:
configuring a set of reference signals;
receiving measured self-interference signal strength from the repeater or the terminal device; and
in accordance with a determination that the self-interference signal strength is smaller than a predefined or preconfigured threshold, determining the indication to indicate that applying the repeater for building the communication.

19. The method of claim 18, wherein the predefined or preconfigured threshold is determined based on at least one of:
a first SINR or SNR report by the repeater,
a second SINR or SNR report by the terminal device,
a transmission power of the repeater, or
a polarization direction of a spatial domain receive filter and a polarization direction of a spatial domain transmission filter.

20. The method of claim 18, further comprising at least one of:
configuring, to the repeater, two repetitions of the set of reference signals for each spatial domain filer pair at the repeater;
configuring, to the repeater, a signaling to switch forward states for each spatial domain filter pairs; or
transmitting a pulse signal, wherein a duration of the pulse signal is smaller than or equal to a sum delay of a delay of receiving signal transmitted to a transmitting module at the repeater and a delay of transmitting signal received in a receiver at the repeater.

21-22. (canceled)
